(19) United States
(12) Patent Application Publication
(10) Pub. No.: US 2007/0176865 A1
(43) Pub. Date: Aug. 2, 2007

(54) LIGHT-EMITTING DEVICE, ELECTRONIC APPARATUS AND IMAGE PROCESSING DEVICE

(75) Inventors: Taketo CHINO, Hokuto-shi (JP); Kazuma KITADANI, Suwa-gun (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/610,585

(22) Filed: Dec. 14, 2006

(30) Foreign Application Priority Data
Feb. 2, 2006 (JP) 2006-025341

(51) Int. Cl. G09G 3/32

(52) U.S. Cl. 345/82

(57) ABSTRACT

Provided is light-emitting device including: a plurality of light-emitting elements which correspond to pixels for configuring an image and emit light by being supplied electric energy; a first storage unit which stores a first correction value with respect to each of the plurality of light-emitting elements; a specifying unit which specifies a first mode or a second mode for each of a plurality of regions dividing the image; and a driving unit which supplies electric energy to each of the plurality of light-emitting elements according to the first correction value of the light-emitting element and image data of a corresponding pixel, for each pixel of a region which the specifying unit has specified as being in the first mode, and supplies electric energy to each of the plurality of light-emitting elements according to the image data of a corresponding pixel of a region which the specifying unit has specified as being in the second mode by a process different from that of the first mode.

### BACKGROUND

1. Technical Field

The present invention relates to a technology for controlling the amount of light emitted from a light-emitting element such as an organic light-emitting diode (hereinafter, referred to as “OLED”) element.

2. Related Art

A light-emitting device in which a plurality of light-emitting elements are arranged is used as a device for outputting an image, such as an exposure device (optical head) of an image forming apparatus and a display device of various kinds of electronic apparatuses. In this kind of light-emitting device, when the amount of light emitted from each light-emitting element is uneven, an irregular gradation occurs in an actually output image. In order to suppress the irregular gradation, for example, JP-A-2003-118163 discloses a technology for previously measuring the amount of the radiation light from each light-emitting element and correcting a pulse width or the value of current supplied to each light-emitting element by the measurement result.

However, in a configuration for always equalizing the light amounts of all the light-emitting elements by correction, the following problems occur. First, since the characteristics of each light-emitting element deteriorates at a speed corresponding to the current supplied thereto, in the configuration of JP-A-2003-118163 in which the amount of light emitted from a light-emitting element is corrected on the basis of he characteristics of the light emitting element, a characteristic deterioration rate is different in each light-emitting element. For example, since a correction for increasing the value of the current supplied to a light-emitting element (that is, a correction for increasing the light amount) is performed on a light-emitting element having low light emission efficiency, the characteristics rapidly deteriorate compared with a light-emitting element having high light emission efficiency. When the deterioration rate is different in each light-emitting element, the difference in characteristics between light-emitting elements increases over time.

In an image forming apparatus for forming a latent image on the surface of a photosensitive drum by exposure of a light-emitting element, the irregular gradation is not caused only by the difference in the luminance of the light (light emission intensity) emitted from each light-emitting element. For example, even when the size or the shape of a spot region (region in which the luminance of the light from each light-emitting element exceeds a predetermined value) on the surface of the photosensitive drum is different for each light-emitting element, an irregular gradation occurs in the image. In this case, although the luminance of each light-emitting element is corrected so as to suppress the irregular gradation due to the difference in the luminance of each light-emitting element, the irregular gradation due to the difference in the configuration (size or shape) of the spot region cannot be necessarily suppressed.

### SUMMARY

An object of the invention is to solve a problem due to a correction for equalizing the light amounts of all light-emitting elements. More specifically, a first advantage of the invention is to suppress characteristic deterioration of each light-emitting element due to a light-amount correction. In addition, a second advantage of the invention is to efficiently suppress plural kinds of irregular gradations which occur by different causes.

According to an aspect of the invention, there is provided a light-emitting device comprising: a plurality of light-emitting elements which correspond to pixels for configuring an image and emit light by being supplied electric energy (for example, driving current); a first storage unit (for example, a ROM 26 or a buff 321 of FIGS. 1, 4 or 9) which stores a first correction value (for example, a correction value Aa) with respect to each of the plurality of light-emitting elements; a specifying unit (for example, a control unit 326 of FIGS. 1, 4 or 9) which specifies a first mode or a second mode for each of a plurality of regions dividing the image; and a driving unit (for example, a correction unit 327 and a driving circuit 24 of FIGS. 1, 4 or 9) which supplies electric energy to each of the plurality of light-emitting elements according to the first correction value of the light-emitting element and image data of a corresponding pixel, for each pixel of a region which the specifying unit has specified as being in the first mode (for example, at the time of outputting each pixel), and supplies electric energy to each of the plurality of light-emitting elements according to the image data of a corresponding pixel of a region which the specifying unit has specified as being in the second mode by a process different from that of the first mode.

In this configuration, the first mode or the second mode is specified to each region of the image. When each pixel of the region specified with the first mode are output, the light-emitting element emits light with the amount of light according to the first correction value. Accordingly, for example, by properly selecting the first correction value according to the characteristics of each light-emitting element, it is possible to suppress an irregular gradation due to difference in the amount of light (luminance) of each light-emitting element with respect to the region specified with the first mode. Meanwhile, when each pixel of the region specified with the second mode are output, the correction according to the first correction value is not executed with respect to the amount of light emitted from the light-emitting element. Accordingly, it is possible to suppress each light-emitting element from deteriorating due to the correction according to the first correction value, compared with a configuration according to the related art, in which the amount of light emitted from each light-emitting element is corrected according to the first correction value at the time of outputting all the pixels for configuring the image.

In addition to a configuration in which any one of the first mode and the second mode is alternatively selected, a configuration (for example, FIG. 9) in which any one of three operation modes including the first mode and the second mode is selected is also in the scope of the invention. In the invention, the “plurality of light-emitting elements” is a portion or all of the light-emitting elements included in the light-emitting device. The “process different from that of the first mode” includes a case where no correction is executed with respect to the light-emitting element as well as a case the amount of light is corrected according to a correction value other than the first correction value.

As described above, at the time of outputting the pixel specified with the second mode, the correction according to the first correction value is not executed with the amount of light emitted from each light-emitting element. Accordingly, each pixel belonging to the region specified with the second mode may be influenced by the difference in the characteristics of each light-emitting element. However, when the configuration (size or shape) of the region which is the unit for specifying the operation mode is properly selected, the difference in the characteristics of each light-emitting element may not be recognized with respect to the region specified with the second mode. In this configuration, the second mode is specified to a plurality of regions of which the positions are dispersed in the image and the second mode is specified to the other regions. In the light-emitting device in which the image is formed by arranging lines including a plurality of pixels arranged in a first direction (for example, a main scanning direction) in correspondence with each of the light-emitting elements in a second direction (for example, a sub-scanning direction) crossing the first direction, a configuration which specifies the first mode or the second mode for each region for dividing the image to a predetermined number of lines is employed in the preferred embodiment, one of the first mode and the second mode is specified to an odd line and the other of the first mode and the second mode is specified to an even line.

The contents of a process executed by the driving unit at the time of outputting the pixel specified with the second mode are arbitrary. The below-described first to fourth aspects relates to the contents of a process for processing the pixel specified with the second mode.

In a first aspect of the invention, the driving unit supplies the electric energy to each of the plurality of light-emitting elements according to the image data of each pixel such that the same electric energy is supplied to the light-emitting elements specified with the same gradation by the image data, for each pixel of a region which the specifying unit has specified as being in the second mode. A specific example of this aspect will be described later as a first embodiment.

In this aspect, since the correction according to the characteristics is not executed with respect to the amount of light emitted from each light-emitting element at the time of outputting each pixel of the region specified with the second mode, it is possible to suppress characteristic deterioration of each light-emitting element, compared with a configuration in which the amount of light emitted from each light-emitting element is corrected according to the first correction value with respect to the whole image.

The driving unit related to an example of the first aspect includes the correction unit (for example, a correction unit 327 of FIGS. 1, 4 or 9) which calculates and outputs the first correction value of the light-emitting element corresponding to the pixel and the image data of each pixel belonging to a region which the specifying unit has specified as being in the first mode and calculates and outputs a common value of each pixel and the image data of each pixel belonging to a region which the specifying unit has specified as being in the second mode, and the driving circuit (for example, the driving circuit 24 of FIGS. 1, 4 or 9) which drives each light-emitting element based on the image data output from the correction unit. In this aspect, since a predetermined calculation is executed with respect to the common value of each pixel and the image data of each pixel of the region specified with the second mode; it is possible to change, for example, only the amount of light emitted from each light-emitting element. The value calculated with the image data may be zero (that is, non-correction).

The driving unit related to another example of the first aspect includes the correction unit (for example, the correction unit 327 of FIG. 4) which calculates and outputs the first correction value of the light-emitting element corresponding to the pixel and the image data of each pixel belonging to the region to which the specifying unit specifies the first mode and outputs the image data of each pixel belonging to the region to which the specifying unit specifies the second mode, and the driving circuit (for example, the driving circuit 24 of FIG. 4) which drives each light-emitting element based on the image data output from the correction unit. In this aspect, since the image data is not subjected to a process such as a calculation for each pixel of the region specified with the second mode, it is possible to simplify the process or the configuration compared with a configuration in which an calculation is executed with respect to the image data of the region of the second mode.

The light-emitting device related to a second aspect of the invention includes a plurality of light-emitting elements which correspond to pixels for configuring an image and emit light to a subject (for example, a photosensitive drum 110) by supplying electric energy, a first storage unit (for example, a ROM 26 or a buff 321 of FIGS. 1 or 9) which stores a first correction value (for example, a correction value Aa) selected in each light-emitting element such that a difference in the amount of light (or luminance) among the plurality of light-emitting elements is suppressed when predetermined electric energy is supplied, a second storage unit which stores a second correction value (for example, a correction value Ab) selected in each light-emitting element such that a difference In the configuration (size or shape) of a spot region (for example, a spot region As of FIG. 6) to which radiation light from the plurality of light-emitting elements supplied with the predetermined electric energy is irradiated in the surface of the subject with an intensity exceeding a predetermined value, a specifying unit (for example, a control unit 326 of FIGS. 1 or 9) which specifies a first mode or a second mode for each of a plurality of regions dividing the image, and a driving unit (for example, a correction unit 327 and a driving circuit 24 of FIGS. 1 or 9) which supplies electric energy according to the first correction value of a corresponding light-emitting element and image data of each pixel to each of the plurality of light-emitting elements, for each pixel of a region to which the specifying unit specifies a first mode, and supplies electric energy according to the second correction value of the corresponding light-emitting element and the image data of each pixel to each of the plurality of light-emitting elements, for each pixel of a region to which the specifying unit specifies a second mode.

In this aspect, at the time of outputting each pixel of the region specified with the first mode, the difference in the amount of light emitted from each light-emitting element is suppressed by the correction according to the first correction value, and at the time of outputting each pixel of the region specified with the second mode, the difference in the configuration of the spot region each light-emitting element is suppressed by the correction according to the second correction value. Accordingly, it is possible to form an image having high image quality and a reduced irregular gradation, compared with a configuration in which only any one of the irregular gradation due to the difference in the amount of light emitted from each light-emitting element and the irregular gradation due to the difference in the configuration of the spot region of each light-emitting element is suppressed.

In a third aspect of the invention, a second storage unit (for example, a ROM 26 or a buffer 322 of FIGS. 1 or 9) which stores the second correction value (for example, a correction value Ab) with respect to each of the plurality of light-emitting elements is further included, and the driving unit drives each of the plurality of light-emitting elements so that the light-emitting element emits an amount of light according to the image data by supplying driving current (for example, driving current Sdr of FIG. 8B) set with a current value according to the first correction value of the corresponding light-emitting element, for each pixel of a region which the specifying unit has specified as being in the first mode, and drives each of the plurality of light-emitting elements so that the light-emitting element emits an amount of light according to the image data by supplying driving current (for example, driving current Sdr of FIG. 8C) set with a pulse width according to the second correction value of the corresponding light-emitting element, for each pixel of a region which the specifying unit has specified as being in the second mode. An example of this aspect will be described later as a third embodiment.

In this aspect, with respect to the region specified with the first mode, the amount of light emitted from each light-emitting element is corrected by setting the current value of the driving current according to the first correction value and, with respect to the region specified with the second mode, the amount of light emitted from each light-emitting element is corrected by setting pulse width of the driving current according to the second correction value. Accordingly, it is possible to suppress characteristic deterioration of the light-emitting element and to improve image quality, compared with a configuration in which the current value of the driving current is corrected with respect to all the pixels of the image or the pulse width of the driving current is corrected with respect to all the pixels.

In a fourth aspect of the invention, a second storage unit (for example, a ROM 26 or a buffer 322 of FIGS. 1 or 9) which stores the second correction value (for example, a correction value Ab) with respect to each of the plurality of light-emitting elements is further included, and the driving unit supplies electric energy according to the second correction value of the corresponding light-emitting element and the image data of each pixel to each of the plurality of light-emitting elements, for each pixel of a region which the specifying unit has specified as being in the second mode. In this aspect, the first correction value and the second correction value are set such that a range (for example, a range R2 of FIG. 5C(2)) in which the intensity of light emitted from each light-emitting element driven according to the second correction value and the image data for specifying a predetermined gradation value is distributed is wider than a range (for example, a range R1 of FIG. 5B(2)) in which the intensity of light emitted from each light-emitting element driven according to the first correction value and the image data for specifying a predetermined gradation value is distributed. That is, when the same gradation value is specified to a predetermined number of light-emitting elements, the first correction value and the second mode are selected such that a difference between a maximum value and a minimum value of the amount of light emitted from each light-emitting element in the first mode is smaller than a difference between a maximum value and a minimum value of the amount of light emitted from each light-emitting element in the second mode. An example of the fourth aspect will be described later as Modified Example 2 (FIG. 5) of the first embodiment.

In this aspect, since the correction degree of the amount of light emitted from each light-emitting element at the time of outputting each pixel related to the second mode is smaller than the correction degree of the amount of light emitted from each light-emitting element at the time of outputting each pixel related to the first mode, it is possible to suppress the characteristic deterioration of each light-emitting element, similar to the light-emitting device related to the first aspect.

In a specific aspect of the invention, the driving unit includes a correction unit (for example, a correction unit 327 of FIGS. 1, 4 or 9) which corrects the image data of each pixel and a driving circuit (for example, a driving circuit 24 of FIGS. 1, 4 or 9) which drives each light-emitting element based on the image data after correction. The correction unit executes a predetermined calculation (for example, addition between the image data and the first correction value) and outputs the image data after calculation to the driving circuit, when the first mode is specified. The driving circuit outputs a driving signal having a pulse width or a level (current value or voltage value) according to the image data output from the correction means and drives each light-emitting element.

The light-emitting device related to the invention may have a function for driving each light-emitting element according to the first correction value and the image data of each pixel and need not necessarily include a unit which calculates the first correction value (or the second correction value) and the image data. For example, the driving unit related to another aspect adjusts the level or the pulse width of a driving signal according to the image data (driving signal having the level or the pulse width according to the image data) and outputs the driving signal to each light-emitting element, when the first mode is specified.

The light-emitting device related to the invention is used in a variety of electronic apparatuses. An example of the electronic apparatus includes an image forming apparatus using the light-emitting device of the invention as an exposure device (exposure head). The image forming apparatus includes an image carrier (for example, a photosensitive drum 110 of FIG. 10) on which a latent image is formed on an image forming surface by exposure and a developer (for example, a developer 114 of FIG. 10) which attaches a developing agent such as a toner to form an image. However, the use of the light-emitting device related to the invention is not limited to the exposure. For example, the light-emitting device of the invention may be used as a display device of a variety of electronic apparatuses. The electronic apparatuses include a personal computer or a mobile telephone. The light-emitting device of the invention may be employed as a variety of illumination device such as a device (backlight) which is disposed on the rear surface of a liquid crystal device and illuminates the liquid crystal display or a device which is mounted in an image reading apparatus such as a scanner and irradiates light onto an original sheet.

The invention is specified as an image processing apparatus used in the light-emitting devices of the above aspects. The image processing apparatus (for example, a controller 32 of FIG. 13 includes a first storage unit (for example, a buffer 321 of FIG. 1) which stores a first correction value with respect to each of a plurality of light-emitting elements, a specifying unit (for example, a control unit 326 of FIG. 1) which specifies a first mode or a second mode for each of a plurality of regions dividing an image, and a correction unit (for example, a correction unit 327 of FIG. 1) which corrects image data of each pixel belonging to a region to which the specifying unit specifies the first mode according to the first correction value stored in the first storage unit and the corrected image data to a light-emitting device and outputs image data of each pixel belonging to a region to which the specifying unit specifies a second mode to the light-emitting device without executing the correction according to the first correction value. By this image processing apparatus, the same operation and effect as those of the light-emitting device of the invention can be obtained. The correction unit may be a unit for outputting the image data without the correction for each pixel of the region specified with the second mode or a unit for correcting and outputting the image data according to a correction value other than the first correction value.

The image processing apparatus of the invention employs the light-emitting device according to the above aspects. For example, in a preferred aspect of the image processing apparatus related to the invention, a second storage unit (for example, a buffer 322 of FIGS. 1 or 9) which stores a second correction value with respect to each of the plurality of light-emitting elements is further include, and the correction unit corrects the image data of each pixel belonging to a region which the specifying unit has specified as being in the second mode according to the second correction value stored in the second storage unit and outputs the corrected image data to the light-emitting device. The image processing apparatus of the invention may be realized by only hardware such as a digital signal processor (DSP) or the cooperation between a computer such as a central processing unit (CPU) and software.

### BRIEF DESCRIPTION OF THE DRAWINGS

The invention will be described with reference to the accompanying drawings, wherein like numbers reference like elements.

FIG. 1 is a block diagram showing the configuration of a light-emitting device according to the present invention.

FIG. 2 is a flowchart illustrating the operation of a control unit.

FIG. 3 is a conceptual diagram illustrating the reduction of an irregular gradation according to a first embodiment.

FIG. 4 is a block diagram showing the configuration of a light-emitting device according to a modified example of the first embodiment.

FIG. 5 is a graph showing a relationship between a correction value Aa and a correction value Ab in the modified example of the first embodiment.

FIG. 6 is a graph showing a spot region.

FIG. 7 is a conceptual diagram illustrating the reduction of an irregular gradation according to a second embodiment.

FIG. 8 is a waveform diagram of driving current according to a third embodiment.

FIG. 9 is a block diagram showing the configuration of a light-emitting device according to a modified example.

FIG. 10 is a cross-sectional view showing the configuration of an electronic apparatus (image forming apparatus according to the present invention.

### DESCRIPTION OF EXEMPLARY EMBODIMENTS

### A: Configuration of Light-Emitting Device

The configuration of a light-emitting device according to an embodiment of the present invention will be described. The light-emitting device is used as an exposure device for exposing a photosensitive drum in an image forming apparatus (printing apparatus) for forming a latent image by exposure of the photosensitive drum. In the present embodiment, it is assumed that an image (latent image) of m×n pixels (m and n are both integers with values of 2 or more) is formed. Hereinafter, a set (one row) of n pixels arranged in a main scanning direction (direction of a rotation axis of the photosensitive drum) in one image is referred to as a “line”.

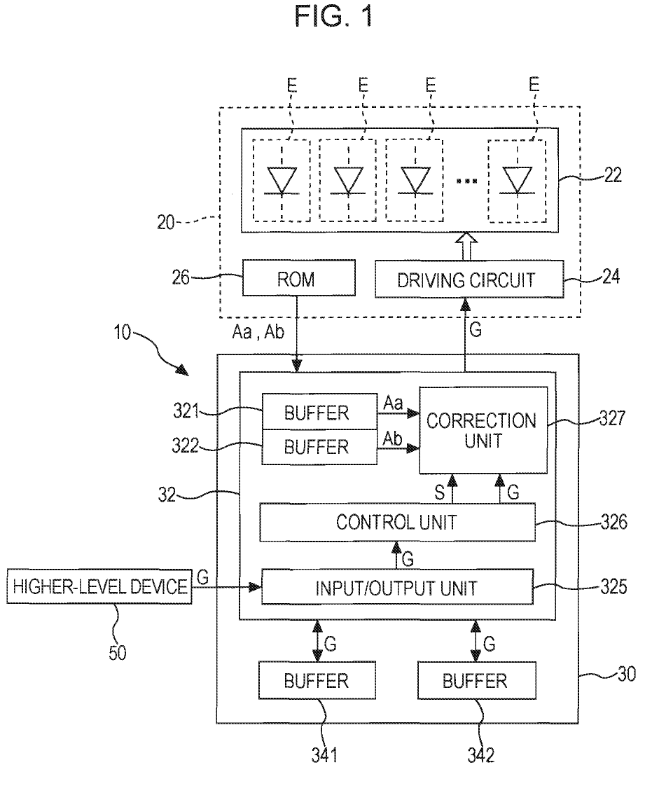

FIG. 1 is a block diagram showing the configuration of a light-emitting device according to the present invention. As shown in the drawing, the light-emitting device 10 includes a head module 20 and a control substrate 30. The head module 20 is a part for radiating a light beam according to a desired image onto the outer circumferential surface (hereinafter, referred to as an “image forming surface”) of the photosensitive drum, and includes an optical head 22, a driving circuit 24 and a ROM 26. The optical head 22 is a part in which n light-emitting elements corresponding to the number of pixels of one line of the image are arranged in the main scanning direction. Each light-emitting element E emits an amount of light according to the electric energy supplied thereto. The light-emitting element E according to the present embodiment is an OLED element in which a light-emitting layer made of an electroluminescence material is interposed in a gap between an anode and a cathode, and emits light with a luminance according to a current during a time period when driving current is supplied to the light-emitting layer.

The driving circuit 24 is a part for driving each light-emitting element E so that the amount of light (luminance and time) emitted is related to image data G by supplying electric energy (driving current) according to the image data G. The image data G is digital data for specifying any one of a plurality of gradation values with respect to each light-emitting element E. The driving circuit 24 according to the present embodiment controls a pulse width of the driving current set to a predetermined value, in accordance with the image data G to control the amount of light emitted from each light-emitting element E (gradation control using a pulse width modulation method). The image forming surface of the photosensitive drum moves in a sub-scanning direction while controlling the amount of light emitted from each light-emitting element E such that a latent image of one page having m×n pixels is formed on the image forming surface.

The ROM 26 is a part for storing a correction value Aa and a correction value Ab in each light-emitting element E in a nonvolatile state. The correction value Aa and the correction value Ab are values for adjusting the amount of light emitted from each light-emitting element E independent of the image data G. The correction value Aa and the correction value Ab are individually set in each light-emitting element E and are different from one another. The contents of the correction value Aa or the correction value Ab or a method for selecting the correction value Aa or the correction value Ab will be described in detail in the following embodiments.

On the control substrate 30, a controller 32 and two buffers 341 and 342 are mounted. The controller 32 receives the image data G from a higher-level device 50 (host computer) such as a CPU of the image forming apparatus in which the light-emitting device 10 is housed. The controller 32 is a part for controlling the head module 20 and includes two buffers 321 and 322, an input/output unit 325, and a correction unit 327. The parts (particularly, the control unit 326 and the correction unit 327) which configure the controller 32 may be hardware such as DSP or the functions thereof may be realized by allowing a computer such as a CPU to execute a program.

When power is applied to the light-emitting device 10, the correction value Aa and the correction value Ab of each light-emitting element E are transmitted from the ROM 26 of the head module 20 to the controller 32 before driving each light-emitting element E. The buffer 321 is a part for storing n correction values Aa transmitted from the ROM 26. Similarly, the buffer 322 is a part for storing n correction values Ab transmitted from the ROM 26.

The buffer 341 and the buffer 342 are parts (line memory) for storing the image data of n pixels belonging to one line of the image. The input/output unit 325 alternately writes the image data G sequentially supplied from the higher-level device 50 in the buffer 341 and the buffer 342 for each line. The input/output unit 325 alternately reads the image data G of each line from the buffer 341 and the buffer 342 and outputs the image data G to the control unit 326. That is, the input/output unit 325 sequentially executes the writing the image data G of odd lines to the buffer 341 and the reading of the image data G of even lines from the buffer 342, and the reading of the image data G of the odd lines from the buffer 341 and the writing the image data G of the even lines to the buffer 342, at a timing synchronized with a horizontal synchronization signal (that is, for every horizontal scanning period). The line in which the image data G is read by the input/output unit 325 is hereinafter referred to as a “target line”. Each of a plurality of m lines for configuring the image is sequentially selected as the target line in order of arrangement according to the subscanning direction.

The control unit 326 is a part for controlling the correction to be executed with respect to the amount of light emitted from each light-emitting element E and outputs a correction management signal S for specifying one of a first mode and a second mode for every line to the correction unit 327. The first mode is an operation mode in which the amount of light emitted from the light-emitting element E is controlled based on the correction value Aa and the image data G of the target line. In contrast, the second mode is an operation mode in which the amount of light emitted from the light-emitting element is controlled based on the correction value Ab and the image data G of the target line.

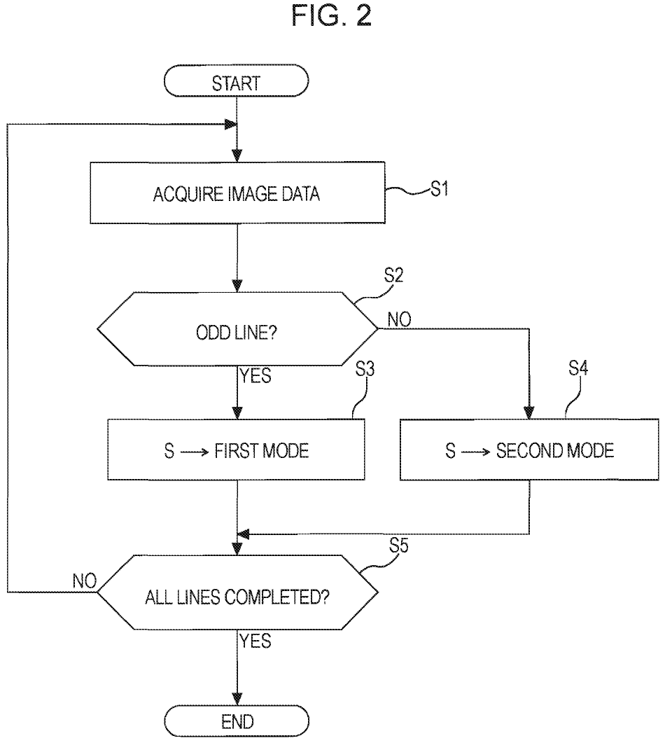

FIG. 2 is a flowchart illustrating the operation of the control unit 326 according to the present embodiment. The process shown in the drawing is executed whenever the image data G of one page is supplied from the higher-level device 50 to the controller 32 (that is, for every vertical scanning period in synchronization with a vertical, synchronization signal). When the process shown in FIG. 2 starts, the control unit 326 first acquires the image data of one line (target line) among the lines sequentially output from the input/output unit 325 (step S1). Next, the control unit 326 determines whether the target line of the image data G acquired in the step S1 is an odd line of m lines for configuring the image or not (step S2). If the result of determination is yes, the control unit 326 outputs the correction management signal S for specifying the first mode to the correction unit 327 together with the image data G of the target line (step S3). In contrast, if the result of determination is no in the step S2 (that is, the target line is the even line), the control unit 326 outputs the correction management signal S for specifying the second mode to the correction unit 327 together with the image data G of the target line (step S4).

Following the step S3 or the step S4, the control unit 326 determines whether the first and second mode have been specified with respect to all the lines of one page or not (step S5). If the result of determination is no, the control, unit 326 acquires the image data G of the next line (target line) from the input/output unit 325 (step S1) and then the process after the step S2 is executed with respect to the new target line. Meanwhile, if the result of the step S5 is yes, the process shown in FIG. 2 is finished.

The correction unit 327 shown in FIG. 1 is a part for processing the image data G of each line supplied from the input/output unit 325 via the control unit 326 in accordance with the correction management signal S. When the first mode is specified by the correction management signal S, the correction unit 327 performs calculation with respect to n correction values Aa held in the buffer 321 and the image data G of the target line and outputs the image data G after the calculation to the head module 20. Meanwhile, when the second mode is specified by the correction management signal S, the correction unit 327 performs calculation with respect to n correction values Ab held in the buffer 322 and the image data G of the target line and outputs the image data G after the calculation to the head module 20. The correction unit 327 according to the present embodiment adds the image data G of a jth (j is an integer satisfying 1≦j≦n) pixel and the correction value Aa or Ab of the jth light-emitting element E and outputs the image data G after the addition to the driving circuit 24.

The driving circuit 24 supplies the electric energy (driving current) according to the image data G to each light-emitting element E. Accordingly, with respect to each line specified with the first mode in one image, each light-emitting element E emits light with the amount of light corrected according to the correction value Aa to form a latent image on the image forming surface of the photosensitive drum. Meanwhile, with respect to each line specified with the second mode, each light-emitting element E emits light with the amount of light corrected according to the correction value Ab to form a latent image on the image forming surface of the photosensitive drum.

Next, embodiments to which the light-emitting device 10 is applied will be described in consideration of the selection of the correction value Aa and the correction value Ab. The following embodiments are exemplary and the contents of the correction value Aa or the correction value Ab or the selecting method thereof is properly modified.

### B-1: First Embodiment

In the present embodiment, the correction value Aa and the correction value Ab are set such that the correction for equalizing the amount of light emitted from each light-emitting element E is selected for every line of the image. First, the correction value Ab of each light-emitting element E is a common value for all the light-emitting elements E. In the present embodiment, it is assumed that the correction value Ab of all the light-emitting elements E is set to “0”. Since the image data G and the correction value Ab are added in the correction unit 327, the correction for equalizing the amount of light emitted from each light-emitting element E is executed with respect to the line specified with the second mode.

Meanwhile, the correction value Aa of each light-emitting element E is selected for every light-emitting element E such that the amount of light emitted from each light-emitting element E is equalized when the same gradation is specified by the image data G. For example, first the driving current having a constant current value and pulse width is supplied to each light-emitting element E and the amount of light emitted from each light-emitting element is measured by a light-receiving element such as a photodiode. Second, an average value of the amounts of light emitted from all the light-emitting elements E is calculated based on the result of measurement (difference in the amount of light prior to correction). Third, each correction value Aa is determined such that the amount of light emitted from each light-emitting element E is adjusted to the average value of the amount of light by correction (correction of the pulse width of the driving current). Accordingly, for example, a large value as the correction value Aa of one of the light-emitting elements E emitting a small amount of light (light-emitting element E having low light emission efficiency) is obtained prior to correction.

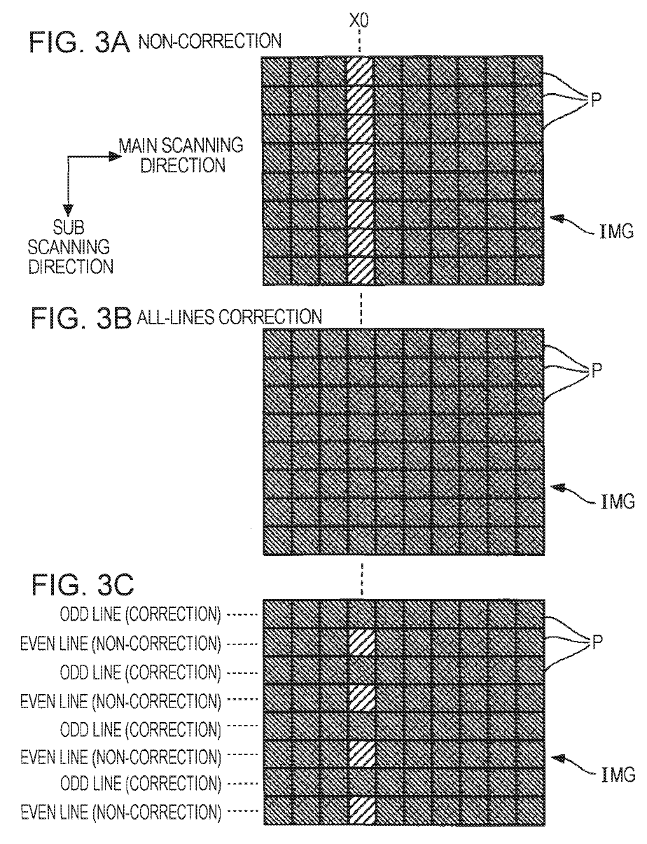

FIG. 3A is a conceptual diagram showing an image (image printed on a sheet of paper) IMG which is actually output from the image forming apparatus when it is assumed that the amount of light emitted from each light-emitting element E is not corrected. In the drawing, it is assumed that the same gradation is specified in all the pixels P for configuring the image IMG. When the light emission efficiency of an X0th light-emitting element E of n light-emitting elements E is lower than that of the other light-emitting elements E (that is, the amount of light of the x0th light-emitting element E is low), as shown in FIG. 3A, the pixels corresponding to the x0th light-emitting element E of the Image IMG output prior to the correction have lower gradation than that of the other pixels P. That is, an irregular gradation having a stripe shape occurs in the sub-scanning direction.

FIG. 3B is a conceptual diagram showing an image IMG when the correction for equalizing the amount of light emitted from each light-emitting element E is performed for all the lines. In this case, since the amount of light of the X0th light-emitting element E increases to the same degree as that of the other light-emitting element E, the irregular gradation is suppressed. The electric energy higher than that of the other light-emitting elements E is supplied to the X0th light-emitting element E over the entire time period when each line of the image IMG is output. Accordingly, the characteristic deterioration becomes severe with respect to the X0th light-emitting element E and thus characteristic difference between the X0th light-emitting element E and the other light-emitting elements E increases over time.

FIG. 3C is a conceptual diagram showing an image IMG which is actually output in the configuration of the present embodiment. Since the amount of light emitted from each light-emitting element E is corrected in accordance with the correction value Aa during a time period when the odd lines of the image IMG are output, the irregular gradations of the X0th pixels P are suppressed. Meanwhile, the amount of light emitted from each light-emitting element E is not corrected (that is, corrected in accordance with the correction value Ab of “0”) during a time period when the even lines of the image IMG are output. That is, since the same electric energy is supplied to all the light-emitting elements E including the X0th light-emitting element E when the even lines are output, the characteristic deterioration of the X0th light-emitting element E does not progress faster than that of the other light-emitting elements E during this time period. Therefore, according to the present embodiment, the characteristic deterioration of each light-emitting element E due to the correction according to the correction value Aa can be suppressed compared with the configuration (FIG. 3B) in which the amount of light emitted from each light-emitting element E is corrected at the time of outputting all the lines.

As shown in FIG. 3C, the pixel P having the corrected gradation and the non-correction pixel P are arranged in the X0th column in the sub-scanning direction, but the difference in gradation is hardly recognized by naked eyes of human. The resolution from a visibility distance in the visual sense of human has a limit (upper limit) of about “10 cycle/mm”. Accordingly, when the image IMG is formed on the surface of the sheet such that at least 10 pixels P are arranged in the sub-scanning direction in a range of a length of 1 mm, the irregular gradations of the X0th pixels P cannot be recognized by naked eyes. That is, according to the present embodiment, it is possible to suppress the characteristic deterioration of each light-emitting element E without reducing image duality recognized by a user.

### B-2: Modified Example of First Embodiment

The first embodiment may be modified as follows.

### (1) MODIFIED EXAMPLE 1

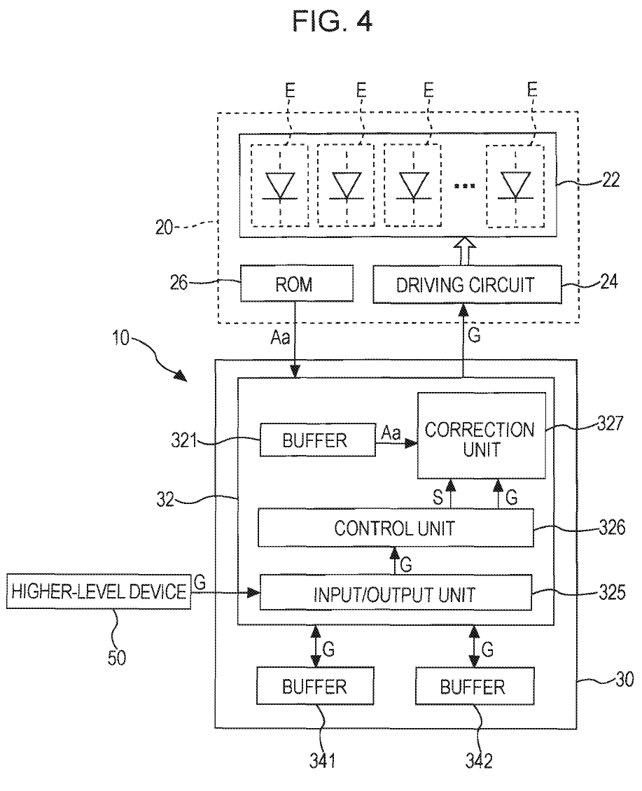

As shown in FIG. 4, a configuration in which the correction value Ab is not set is employed. In the drawing, the buffer 322 for storing the correction value Ab is omitted and the correction value Ab is not stored in the ROM 26. The correction unit 327 outputs the image data G of the line specified with the second mode to the driving circuit 24 without executing any calculation. Even in this configuration, since the amount of light emitted from each light-emitting element E is not corrected with respect to the line specified with the second mode, the same effect as that of the above-described embodiment is obtained. According to the configuration shown in FIG. 4, since a part for scoring the correction value Ab (the buffer 322 shown in FIG. 1) or a wiring for transmitting the correction value Ab is unnecessary, the configuration of the light-emitting device 10 is simplified or the circuit scale is reduced, compared with the configuration of FIG. 1.

### (2) MODIFIED EXAMPLE 2

Although the amount of light emitted from each light-emitting element E is not corrected with respect to the line of the second mode in the first embodiment, correction for reducing the deterioration of each light-emitting element E may be executed with respect to each line of the second mode, compared with the first mode. By this configuration, it is possible to suppress the irregular gradation due to the difference in the characteristics of each light-emitting element E with respect to the line specified with the second mode (the even line of FIG. 3C). In the present modified example, a relationship between the correction value Aa and the correction value Ab is as follows.

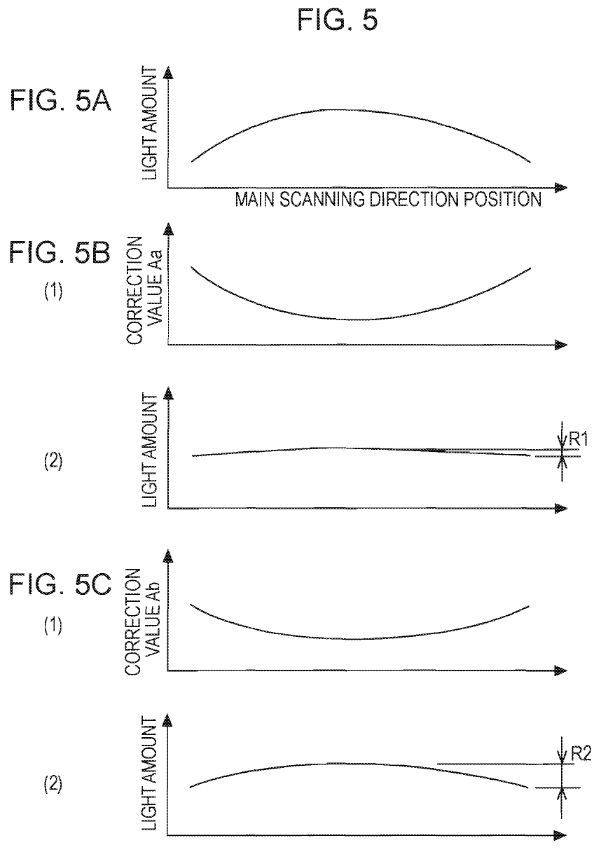

FIG. 5A is a graph showing a relationship between the position (abscissa) of each light-emitting element E in the main scanning direction and the amount of light ordinate) of each light-emitting element E upon the non-correction when the same gradation is specified. In the drawing, it is assumed that the amount of light emitted from the light-emitting element E in the center of the main scanning direction of the optical head 22 is more than that of each light-emitting element E of the both ends thereof.

FIG. 5B(1) is a graph showing a relationship between the position of each light-emitting element E and the correction value Aa. In FIG. 5B(2), the amount of light emitted from each light emitting diode E corrected based on the correction value Aa in the first mode is shown. As shown in FIG. 5B(1) and 5b(2), the correction value Aa is selected such that the amount of light emitted from each light-emitting element E is substantially equalized (for examples falls into a range R1) by correction using the correction value Aa.

FIG. 5C(1) is a graph showing a relationship between the position of each light-emitting element E and the correction value Ab. In FIG. 5C(2), the amount of light emitted from each light emitting diode E corrected based on the correction value Ab in the second mode is shown. As shown in FIGS. 5C(1) and 5C(2), the correction value Ab is selected such that the difference in the actual amount of light emitted from each light-emitting element E is suppressed compared with the non-correction (FIG. 5A), similar to the correction value Aa. The correction value Ab of each light-emitting element E is set to a value smaller than the correction value Aa of the light-emitting element E. Therefore, as shown in FIG. 5C(2), the amount of light each light-emitting element E after the correction according to the correction value Ab is not perfectly equalized. That is, in the present embodiment, the correction value Aa and the correction Ab are selected according to the difference in the amount of light emitted from each light-emitting element E such that a range (a range R2 of FIG. 5C(2)) in which the amount of light emitted from each light-emitting element E (the amount of light corrected by the correction value Ab) is distributed at the time of driving due to the second mode is wider than a range (a range R1 of FIG. 5B(2)) in which the amount of light emitted from each light-emitting element (the amount of light corrected by the correction value Aa) is distributed at the time of driving due to the first mode.

As described above, the correction degree of the amount of light (the variation in the amount of light) of each light-emitting element E is reduced with respect to the line specified with the second mode, compared with the line specified with the first mode. Accordingly, it is possible to suppress the characteristic deterioration of each light-emitting element E, compared with the configuration in which the correction value Aa, which is selected such that the amount of light emitted from each light-emitting element E is equalized, is applied to all the lines regardless of the contents of the image.

### C: Second Embodiment

The cause of the irregular gradation in the image output from the image forming apparatus is various. For example, a case where the configuration (size or shape) of a spot region in the image forming surface of the photosensitive drum is different in each light-emitting element E as well as a case where the luminous intensities (light emission intensities) of the light-emitting elements E are different, the irregular gradation occurs. Accordingly, both an irregular gradation (hereinafter, referred to as a “first irregular gradation”) due to the difference in the luminance of each light-emitting element E and an irregular gradation (hereinafter, referred to as a “second irregular gradation”) due to the difference in the configuration of the spot region corresponding to each light-emitting element E exist in the image which is actually output. In this case, although the first irregular gradation is suppressed by the correction of the amount of light according to the correction value Aa, the second irregular gradation is not necessarily suppressed. In view of such circumferences, in the present embodiment, the correction value Aa is selected in each light-emitting element E such that the first irregular gradation is suppressed and the correction value Ab is selected in each light-emitting element E such that the second irregular gradation is suppressed.

The correction value Aa is determined in the same order as that of the first embodiment. First, the driving current having the same current value and the pulse width is supplied to each light-emitting element E and the amount of light emitted from each light-emitting element is measured by the light-receiving element. Second, an average value of the amounts of light of all the light-emitting elements E is calculated based on the result of measurement. Third, each correction value Aa is determined such that the amount of light emitted from each light-emitting element E is adjusted to the average value by correction (correction of the pulse width of the driving current).

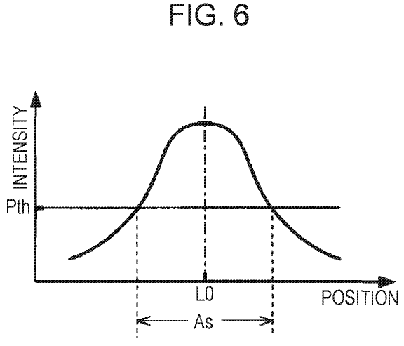

The correction value Ab is, for example, determined by the following order. First, the area (hereinafter, referred to as a “spot area”) of the spot region is individually measured in each light-emitting element E. For example, a plurality of light-receiving element such as CCD elements is arranged in a matrix on the position of the image forming surface of the photosensitive drum. Second, n light-emitting elements E sequentially emit light by supplying the driving current having the same current value and pulse width. Third, based on the result of detection using the light-receiving elements, the in-plane distribution of the intensity of the light beam which is irradiated from one light-emitting element E to the image forming surface of the photosensitive drum is measured. FIG. 6 is a graph showing a distribution of the intensity (luminance) in a plane parallel to an optical axis of the light-emitting element E. As shown in the drawing, the intensity of the light beam which is irradiated to the image forming surface is distributed to be reduced by the position separated from the optical axis L0 of the light-emitting element E. In this distribution, the region to which the light beam having the intensity exceeding a predetermined threshold value Pth (for example, 1/e2) is irradiated is the spot region As. The spot area is calculated by the number of light-receiving elements which receive the light beam exceeding the threshold value Pth when the spot area of each light-emitting element is calculated by the above sequence, an average value of the spot areas of the n light-emitting elements E is calculated. Then, the correction value Ab is set in, each light-emitting element E such that the spot area of each light-emitting element E is adjusted to the average value by the correction of the amount of light.

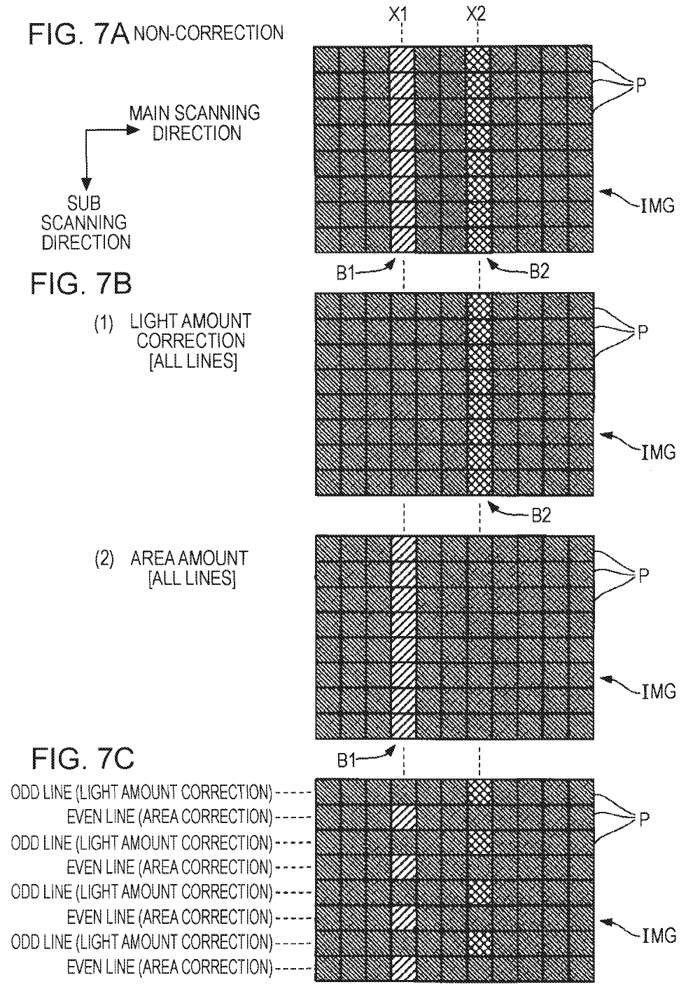

FIG. 7 is a conceptual diagram showing an image which is actually output from the image forming apparatus when the same gradation is specified in all the pixels P for configuring the image IMG. In FIG. 7A, an image IMG when the amount of light emitted from each light-emitting element E is not corrected is shown. When the luminance of an X1th light-emitting element E of the n light-emitting elements E is lower than that of the other light-emitting elements E, the x1th pixels P of the image IMG have a gradation lower than that of the other pixels P, similar to FIG. 3A. When the spot area of an X2th light-emitting element E of the n light-emitting element E is smaller than that of the other light-emitting element E, as shown in FIG. 7A, the X2th pixels of the image IMG have a gradation lower than that of the other pixels P. That is, both the first irregular gradation B1 due to the difference in the luminance of each light-emitting element E and the second irregular gradation B2 due to the difference in the spot area of each light-emitting element E exist in the image IMG.

With respect to the light-emitting diode E having both a luminance and a spot area smaller than respective predetermined values, the first irregular gradation B1 and the second irregular gradation B2 are simultaneously suppressed by the correction for increasing the amount of light. With respect to the light-emitting diode E having both a luminance and a spot area larger than respective predetermined values, the first irregular gradation B1 and the second irregular gradation B2 are simultaneously suppressed by the correction for decreasing the amount of light. However, with respect to the light-emitting element E having a luminance higher than the predetermined value and a spot area smaller than the predetermined value, when the amount of light decreases in order to suppress the first irregular gradation B1, the spot area is further reduced (that is, the second irregular gradation B2 becomes severe), and, when the amount of light increases in order to suppress the second irregular gradation, the first irregular gradation becomes severe. With respect to the light-emitting element E having a luminance lower than the predetermined value and a spot area larger than the predetermined value, the suppression of the first irregular gradation B1 and the suppression of the second irregular gradation B2 are incompatible. With respect to this light-emitting element E, the first irregular gradation B1 and the second irregular gradation B2 cannot be simultaneously suppressed by one correction value.

Accordingly, although the correction for suppressing the first irregular gradation B1 is executed with respect to all the lines of the image IMG, as shower in FIG. 7B(1), the second irregular gradation B2 of the X2th light-emitting element due to the difference in the spot area is not suppressed (becomes severe). Similarly, although the second irregular gradation B2 is suppressed by the correction for equalizing the spot area of each light-emitting element E, as shown in FIG. 7B(2), the first irregular gradation B1 of x1th light-emitting element due to the difference in the luminance is not suppressed.

FIG. 7C is a conceptual diagram showing an image IMG which is actually output in the configuration of the present embodiment. In the present embodiment, the amount of light emitted from each light-emitting element E is corrected in accordance with the correction value Aa at the time of outputting the line specified with the first mode. Accordingly, in the X1th pixels P belonging to the odd line, the first irregular gradation B1 due to the difference in the luminance of each light-emitting element E is suppressed. The amount of light emitted from each light-emitting element E is corrected in accordance with the correction value Ab at the time of outputting the line specified with the second mode. Accordingly, in the X2th pixels P belonging to the even line, the second irregular gradation B2 due to the difference in the spot area of each light-emitting element E is suppressed.

As shown in FIG. 7C, the second irregular gradation B1 remains in the X2th pixels P belonging to the odd line. However, the pixels P (odd) which are not corrected with respect to the second irregular gradation B2 and the pixels (even) which are corrected with respect to the second irregular gradation B2 are arranged in the X2th column with a sufficiently small pitch in the sub-scanning direction. Accordingly, similar to the X0th column shown in FIG. 3C, the X2th irregular gradation cannot be recognized by the naked eyes of human in FIG. 7C. The same is true in the first irregular gradation B1 which remains in the X1th pixel P belonging to the even line. As described above, in the present embodiment, since the first irregular gradation due to the difference in the luminance of each light-emitting element E and the second irregular gradation B2 due to the difference in the configuration of the spot region of each light-emitting element E are alternately suppressed for each line, the image quality recognized by the user can be higher than that of the configuration (FIG. 7B(1) or 7B(2)) in which only any one of the irregular gradations is suppressed.

### D: Third Embodiment

The irregular gradation due to the difference in the luminance of each light-emitting element E is suppressed by the correction of the amount of light emitted from each light-emitting element E. Meanwhile, the amount of light radiated from each light-emitting element E is determined in accordance with the current value of the driving current supplied to each light-emitting element E (the luminance of the light-emitting element E) and the pulse width of the driving current (time period when the light-emitting element E emits light). Accordingly, the irregular gradation due to the difference in the luminance of each light-emitting element E 1s suppressed by properly adjusting at least one of the current value and the pulse width of the driving current, as described above.

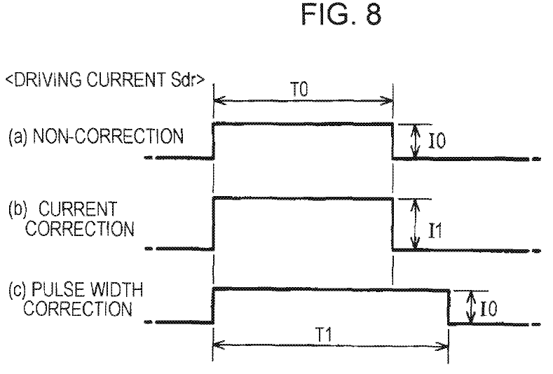

FIG. 8 is a conceptual diagram showing a waveform of the driving current Sdr supplied to the light-emitting element E when a predetermined gradation value is specified by the image data G. In FIG. 8A, the driving current Sdr (current value I0 and pulse width T0) supplied to the light-emitting element E of which the amount of light is not corrected (that is, the light-emitting element E having the amount of light equal to the predetermined value) is shown. Now, it is assumed that the light-emitting element E has the amount of light less than the predetermined value. With respect to this light-emitting element E, first, as shown in FIG. 8B, it is possible to correct (increase) the amount of light to the predetermined value by supplying the driving current Sdr (pulse width T0) set to a current value I1 higher than the current value I0. Second, as shown in FIG. 8C, it is possible to increase the amount of light emitted from the light-emitting element E to the predetermined value by setting the driving current Sdr (current value I0) to a pulse width T1 longer than the pulse width T0.

The characteristics of the light-emitting element E deteriorates at a speed proportional to M-th power of the current value of the driving current Sdr. The “M” is a value determined according to a material, a structure or a manufacturing method of the light-emitting element E (M>1) and is, for example, “2” or “3”. Meanwhile, the characteristics of the light-emitting element E deteriorate at a speed proportional to the pulse width of the driving current Sdr. That is, the operation for increasing the amount of light emitted from the light-emitting element E is common however, as shown in FIG. 8C, when the pulse width increases (T0→T1) while the current value I0 of the driving current Sdr is maintained, the deterioration of the light-emitting element E can be suppressed (long life span), compared with in the case where the current value of the driving current Sdr increases (I0→I1) as shown in FIG. 8B.

Meanwhile, as the time period of the light emission of the light-emitting element E is short, the image formed on the photosensitive drum is clear. Accordingly, as shown in FIG. 8B, when the current value of the driving current Sdr increases (I0→I1) while the pulse width T0 is maintained, the pixel is clear and an image having high image quality can be formed, compared with the case where the pulse width of the driving current increases (T0→T1)

In the present embodiment, in view of the above circumferences, the amount of light emitted from each light-emitting element E is equalized by the correction of the current value of the driving current Sdr at the time of outputting the line specified with the first mode and the amount of light emitted from each light-emitting element E is equalized by the correction of the pulse width of the driving current Sdr at the time of outputting the line specified with the second mode. More specifically, at the time of outputting the odd line, the correction unit 327 controls the driving circuit 24 such that the driving current Sdr having the current value (for example, the current value I1 of FIG. 8) according to the correction value Aa of each light-emitting element E and the pulse width (for example, the pulse width T0 of FIG. 8) according to the image data G of the light-emitting element E is supplied to each light-emitting element E. Meanwhile, at the time of outputting the even line, the correction unit 327 controls the driving circuit 24 such that the driving current Sdr having the predetermined current value T0 and the pulse width according to the correction value Ab and the image data G of each light-emitting element E is supplied to each light-emitting element E.

According to the above configuration, since the amount of light emitted from each light-emitting element E is equalized by the correction of the current value of the driving current Sdr with respect to the odd line specified with the first mode, each pixel is clear and an image having high image quality can be formed, compared with the configuration in which the amount of light emitted from each light-emitting element is equalized only by the correction of the pulse width of the driving current Sdr with respect to all the lines. Since the amount of light emitted from each light-emitting element E is equalized by the correction of the pulse width of the driving current Sdr with respect to the even line specified with the second mode, the characteristic deterioration of each light-emitting element E can be suppressed, compared with the configuration in which the amount of light emitted from each light-emitting element is equalized only by the correction of the current value of the driving current Sdr with respect to all the

### E. MODIFIED EXAMPLE

In the above embodiments, a variety of modifications may be added. The modified examples are as follows. The following examples may be properly combined. Hereinafter, the correction value Aa and the correction value Ab may be collectively referred to a “correction value A”.

### (1) MODIFIED EXAMPLE 1

Although the ROM 26 for storing the correction value A (Aa or Ab) is mounted in the head module 20 in the above embodiments, the correction value A may be previously maintained in the controller 32. Since the correction value A corresponds to the characteristics of each light-emitting element E, when the light-emitting device 10 in which the correction value A is maintained in the controller 32 is manufactured, the correspondence between the head module 20 and the controller 32 need be strictly managed in each light-emitting device 10. In contrast, in the above embodiments in which the correction value A is stored in the head module 20, it is possible to employ a common controller 32 with respect to all the light-emitting devices 10 even when the properties of the light-emitting elements E are different in each light-emitting device 10. Accordingly, since the correspondence between the head module 20 and the controller 32 need not be managed, it is possible to simplify the method for manufacturing the light-emitting device 10.

### (2) MODIFIED EXAMPLE 2

Although the configuration in which the operation mode is decided in the unit of one line is embodied in the above embodiments, a range for deciding the operation mode may be changed. For example, the configuration in which the operation mode is specified in the unit of a plurality of lines may be employed. The range which is the unit for deciding the operation mode need not be a region in the main scanning direction. For example, the operation mode may be decided in the unit of a set of consecutive pixels in each column in the sub-scanning direction.

Although the line specified with the first mode and the line specified with the second mode are alternately arranged in the above embodiments, the arrangement of the lines specified with the modes is arbitrary. For examples any one of the first mode and the second mode is specified with respect to a plurality of lines which is dispersed in the image in the sub-scanning direction and the other one of the first mode and the second mode is specified by with respect to the other lines.

### (3) MODIFIED EXAMPLE 3

In the above embodiments, the configuration in which the driving current having the pulse width according to the image data G is supplied to each light-emitting element E is embodied. In this configuration, the pulse width of the driving current is corrected according to the correction value A. However, in the invention, the target controlled according to the image data G is not limited to the pulse width. For example, a configuration in which the current value of the driving current supplied to each light-emitting diode E is controlled according to the image data G or a configuration in which the voltage value of a voltage (hereinafter, referred to as a “driving voltage”) applied to each light-emitting element E is controlled according to the image data G may be employed. In other words, a configuration in which the current value of the driving current or the voltage value of the driving voltage is corrected according to the correction voltage A may be employed.

### (4) MODIFIED EXAMPLE 4

Although the light-emitting device used in the exposure of the photosensitive drum is embodied in the above embodiments, the light-emitting device according to the invention may be employed as a device for displaying a variety of images. In the light-emitting device used as the display device, a plurality of light-emitting elements E is arranged in a matrix in a row direction and a column direction and a selection circuit (scanning-line driving circuit) for sequentially selecting the light-emitting devices in each row is arranged. By supplying the driving current from the driving circuit 24 to each light-emitting element E in a row selected by the selection circuit, each light-emitting element E emits light with the amount of light according to the image data G.

### (5) MODIFIED EXAMPLE 5

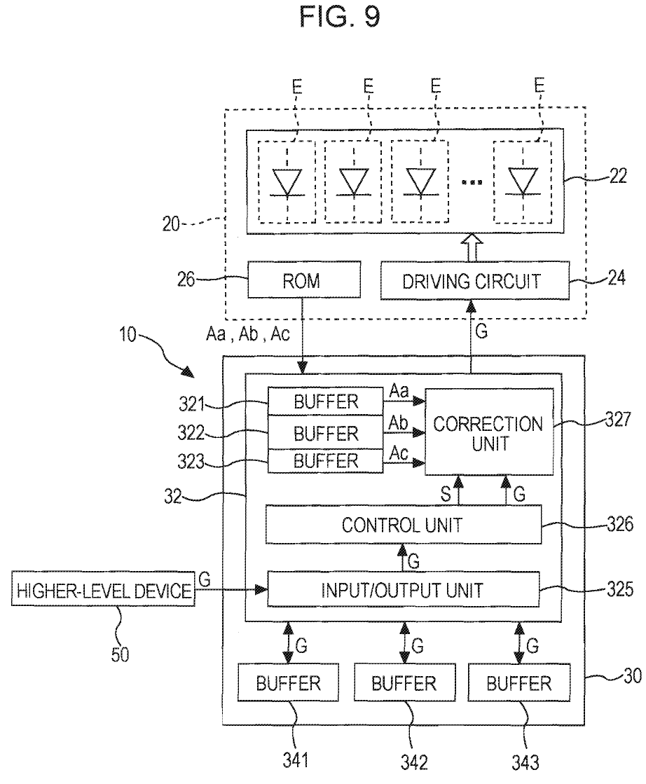

Although a configuration in which any one of the first mode and the second mode is selected is embodied in the above embodiments, a configuration in which an operation mode (that is, the correction value A used for correcting the amount of light emitted from each light-emitting element E) applied to the output of each line is selected from a plurality of operation modes may be employed. For example, the light-emitting device 10 shown in FIG. 9 has a configuration in which the amount of light of one light-emitting element E is corrected by any one of three correction values Aa, Ab and Ac. The n correcting values Ac corresponding to the light-emitting elements E are stored in the buffer 323. The above embodiments are applicable to a method for selecting one from the correcting values A.

The input/output unit 325 executes the read and the writing the image data G of each line with respect to three buffers 341 to 343. The image data G of a (3N-2) line is stored in the buffer 341, the image data G of a (3N-1) line is stored in the buffer 342, and the Image data of a 3N line is stored in the buffer 343. The control unit 326 specifies the first mode in the (3N-2) line, specifies the second mode in the (3N-1) line, and specifies a third mode in the 3N line. The correction unit 327 executes a calculation of the image data G of the lines specified with the first mode and the second mode according to the correction value Aa and the correction value Ab and outputs the result of calculation, similar to the above embodiments. The correction unit 327 executes a certain calculation (for example, addition) of the image data G of the line specified with the third mode and the correction value Ac stored in the buffer 323 and the result of calculation to the driving circuit 24.

According to the configuration shown in FIG. 9, since the amount of light emitted from the light emitting element E of each line can be corrected by a variety of correction values A compared with the above embodiments, it is possible to efficiently reduce the irregular gradation of the image. Although the number of the correction values A of one light-emitting element is three, a configuration in which a plurality of correction values A is prepared (a configuration in which any one of a plurality of operation modes is specified with respect to each line) may be employed.

### (6) MODIFIED EXAMPLE 6

The above embodiments may be properly combined. For example, a configuration in which the first embodiment and the second embodiment are combined may be employed. In this configuration, at the time of outputting the line (even) specified with the second mode, the correction of the amount of light emitted from each light-emitting element E is not executed. Meanwhile, with respect to the odd pixel of the line (odd) specified with the first mode, the first irregular gradation due to the difference in the amount of light emitted from each light-emitting element E is suppressed, and, with respect to the even pixel of the line specified with the first mode, the second irregular gradation due to the difference in the spot area of each light-emitting element E is suppressed. In the configuration in which the first embodiment and the third embodiment are combined, with respect to the odd pixel of the line specified with the first mode, the amount of light emitted from each light-emitting element E is equalized by the correction of the current value of the driving current Sdr, and, with respect to the even pixel, the amount of light emitted from each light-emitting element E is equalized by the correction of the pulse width of the driving current Sdr.

### (7) MODIFIED EXAMPLE 7

Although the OLED element is used as the light-emitting element E in the above embodiments, the invention is not limited to the light-emitting element employed in the light-emitting device. For example, instead of the OLED element, the invention is applicable to a variety of light-emitting elements such as an inorganic EL element, a light-emitting diode element, a field emission (FE) element, a surface-conduction electron-emission (SE) element, a ballistic electron surface emission (BS) element, similar to the above embodiments. The light-emitting element of the invention may be an element for emitting light by supplying electric energy, regardless of a current driving type which is driven by supplying current or a voltage driving type which is driven by supplying a voltage.

### F: Electronic Apparatus

Next, an example of an electronic apparatus according to the invention will be described.

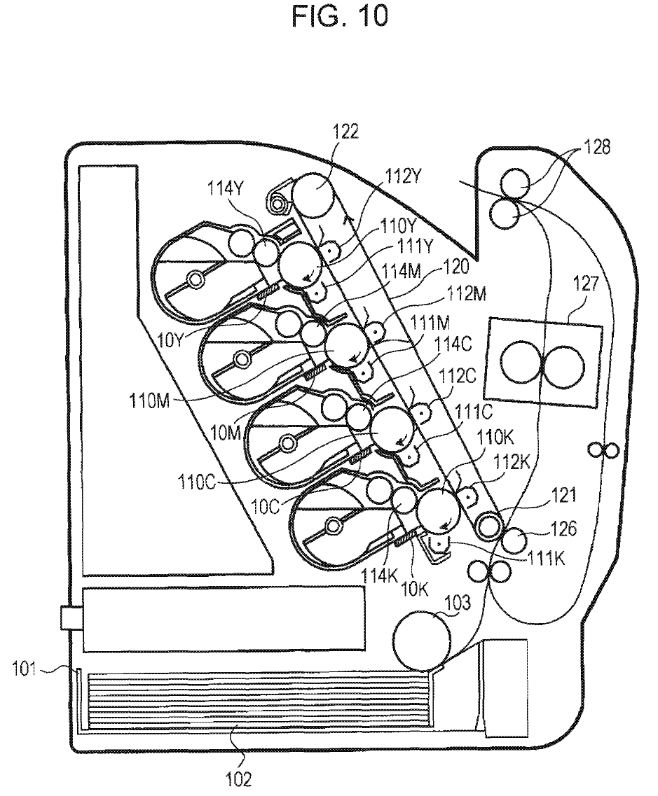

FIG. 10 is a cross-sectional view showing the configuration of an image forming apparatus using the light-emitting device according to the above embodiments. The image forming apparatus is a tandem type full-color image forming apparatus and includes four light-emitting devices 10 (10K, 10C, 10M and 10Y) related to the above embodiments and four photosensitive drums 110 (110K, 110C, 110M and 110Y) corresponding to the respective light-emitting devices 10. One light-emitting device 10, faces the image forming surface (outer circumferential surface) of the photosensitive drum corresponding thereto. Additional characters “K”, “C”, “M” and “Y” of the reference numerals means that they are used for forming an image of black (K), cyan (C), magenta (M) and yellow (Y).

As shown in FIG. 10, an endless transfer belt 120 is wound on a driving- roller 121 and a driven roller 122. The four photosensitive drum 110 are arranged in the vicinity of an intermediate transfer belt at a predetermined gap. The respective photosensitive drums 110 rotate in synchronization with the drive of the intermediate transfer belt 120.

In addition to the light-emitting device 10, corona chargers 111 (111K, 111C, 111M and 111Y) and developers 114 (114K, 114C, 114M and 114Y) are arranged in the vicinities of respective photosensitive drums 110. The corona chargers 111 uniformly charge the image forming surfaces of the photosensitive dramas 110 corresponding thereto. Each light-emitting device 10 exposes the charged image forming surface according to the image data G to form an electrostatic latent image. Each developer 114 attaches a developing agent (toner) on the electrostatic latent image to form an image (visible image) on the photosensitive drum 110.

As described above, the image of each color (black, cyan, magenta and yellow) formed on the photosensitive drum 110 is transferred (primary transfer) to the surface of the intermediate transfer belt 120 to form a full-color image. Four primary transfer corotron (transfer unit) 112 (112K, 112C, 112M and 112Y) are arranged at the inside of the intermediate transfer belt 120. Each primary transfer corotron 112 electrostatically sucks the image from the photosensitive drum 110 corresponding thereto such that the image is transferred to the intermediate transfer belt 120 which masses through a gap between the photosensitive drum 110 and the primary transfer corotron 112.

A sheet (recording material) 102 is fed from a feed cassette 101 by a pickup roller 103 one sheet by one sheet and carried to a nip between the intermediate transfer belt 120 and a secondary transfer roller 126. The full-color image formed on the surface of the intermediate transfer belt 120 is transferred to one surface of the sheet 102 by the secondary transfer roller 126 and fixed on the sheet 102 by passing through a pair of fixing rollers 127. A pair of ejection rollers 128 ejects the sheet 102 on which the image is fixed by the above process.

Since the above image forming apparatus uses the OLED element as a light source (exposure means), the apparatus has smaller size compared with a configuration using a laser scanning optical system. The invention is applicable to an image forming apparatus having the other configuration. For example, the light-emitting device according to the invention is applicable to a rotary development type image forming apparatus, an image forming apparatus for directly developing an image from a photosensitive drum onto a sheet without using an intermediate transfer belt, or an image forming apparatus for forming a monochrome image.

The use of the light-emitting device according to the invention is not limited to the exposure of a photosensitive body. For example, the light-emitting device according to the invention is employed in an image reading apparatus as a line type optical head (illumination device) for irradiating light onto a read object such as an original sheet. As this image reading apparatus, there is a scanner, a reading part of a copier or a facsimile, a barcode reader, or a two-dimensional image code reader for reading a two-dimensional image code such as a QR code (registered trade name). A light-emitting device in which a plurality of light-emitting elements is arranged in a planar shape is employed as a backlight unit arranged on a rear side of a liquid crystal panel.

The light-emitting device of the invention is used as a display device of a variety of electronic apparatuses. As an electronic apparatus to which the light-emitting device of the invention is applicable, there is an apparatus including a handheld personal computer, a mobile telephone, a personal digital assistant (PDA), a digital still camera, a television, a video camera, a car navigation device, a pager, an electronic notebook, an electronic paper, an electrical calculator, a word processor, a workstation, a television telephone, a POS terminal a printer, a scanner, a copier, a video player or a touch panel.

The entire disclosure of Japanese Patent Application No. 2006-025341, filed Feb. 2, 2006 is expressly incorporated by reference herein.

What is claimed is:

1. A light-emitting device comprising:
a plurality of light-emitting elements which correspond to pixels for configuring an image and emit light by being supplied electric energy;
a first storage unit which stores a first correction value with respect to each of the plurality of light-emitting elements;
a specifying unit which specifies a first mode or a second mode for each of a plurality of regions dividing the image; and
a driving unit which supplies electric energy to each of the plurality of light-emitting elements according to the first correction value of the light-emitting element and image data of a corresponding pixel, for each pixel of a region which the specifying unit has specified as being in the first mode, and supplies electric energy to each of the plurality of light-emitting elements according to the image data of a corresponding pixel of a region which the specifying unit has specified as being in the second mode by a process different from that of the first mode.

2. The light-emitting device according to claim 1, wherein the image is formed by arranging lines including a plurality of pixels arranged in a first direction in correspondence with each of the light-emitting elements in a second direction crossing the first directions and wherein the specifying unit specifies the first mode or the second mode for each region dividing the image to a predetermined number of lines.

3. The light-emitting device according to claim 2, wherein the specifying unit specifies one of the first mode and the second mode for an odd line and specifies the other of the first mode and the second mode for an even line.

4. The light-emitting device according to claim 1, further comprising a second storage unit for storing a second correction value for each of the plurality of light-emitting elements,
wherein the driving unit supplies electric energy to each of the plurality of light-emitting elements according to the second correction value of the light-emitting element and the image data of each pixel, for each pixel of a region which the specifying unit has specified as being in the second mode.

5. The light-emitting device according to claim 4, wherein the driving unit drives each of the light-emitting elements so that the light-emitting element emits an amount of light according to the image data by supplying a driving current set with a current value according to the first correction value of the corresponding light-emitting element, for each pixel of a region which the specifying unit has specified as being in the first mode, and drives each of the plurality of light-emitting elements so that the light-emitting element emits an amount of light according to the image data by supplying a driving current set with a pulse width according to the second correction value of the light-emitting element, for each pixel of a region which the specifying unit has specified as being in the second mode.

6. An electronic apparatus comprising the light-emitting elements according to claim 1.

7. An image processing apparatus in which each of a plurality of light-emitting elements corresponding to pixels for configuring an image is driven by supplying electric energy according to image data, the apparatus comprising:
a first storage unit which stores a first correction value with respect to each of the plurality of light-emitting elements;
a specifying unit which specifies a first mode or a second mode for each of a plurality of regions for dividing the image; and
a correction unit which corrects image data of each pixel belonging to a region which the specifying unit has specified as being in the first mode according to the first correction value stored in the first storage unit and outputs the corrected image data to a light-emitting device, and outputs image data of each pixel belonging to a region which the specifying unit has specified as being in the second mode to the light-emitting device without executing the correction according to the first correction value.

8. The image processing apparatus according to claim 7, further comprising a second storage unit for storing a second correction value for each of the plurality of light-emitting elements,
wherein the correction unit corrects the image data of each pixel belonging to the region which the specifying unit has specified as being in the second mode according to the second correction value stored in the second storage unit and outputs the corrected image data to the light-emitting device.
